(19) United States
(12) Patent Application Publication
(10) Pub. No.: US 2013/0036220 A1
(43) Pub. Date: Feb. 7, 2013

(54) Apparatus and Method for Implementing Point to Point Protocol Data Service Link-Disconnect

(71) Applicant: Xiaomei Yan, Shenzhen (CN)

(72) Inventor: Xiaomei Yan, Shenzhen (CN)

(73) Assignee: ZTE CORPORATION, Shenzhen City, Guangdong Province (CN)

(21) Appl. No.: 13/580,192

(22) PCT Filed: Jul. 20, 2010
(86) PCT No.: PCT/CN2010/075301

§ 371 Date: Aug. 21, 2012

(30) Foreign Application Priority Data
Apr. 26, 2010 (CN) 201010155205.9

(51) Int. Cl. G06F 15/173

(52) U.S. Cl. 709/224

(57) ABSTRACT

An apparatus and method for implementing Point to Point Protocol (PPP) data service link disconnection are disclosed in the present invention. The apparatus is set in a terminal and comprises: a detection module, a processing module and a link disconnection module, wherein, the detection module is used for detecting the state of a Personal Computer (PC) connected with the terminal when the terminal performs the PPP data service in a dormant state, and notifying the processing module when determining that the PC is currently in an unavailable state; the processing module is used for sending a link disconnection request to the network side when knowing that the PC in the unavailable state, and triggering the link disconnection module when receiving a link disconnection request acknowledgement from the network side; the link disconnection module is used for disconnecting the PPP link carrying the PPP data service.

### TECHNICAL FIELD

The present invention relates to the field of database technology, and more especially, to an apparatus and method for implementing point to point protocol data service link disconnection.

### BACKGROUND OF THE RELATED ART

In the CDMA PPP (Point to Point Protocol) data service in the prior art, the user uses a USB data cable to connect a personal computer (PC) with a CDMA terminal, and if the user requests to disconnect the PPP link carrying PPP data service between the PC side and the network side by clicking the link icon in the PC, the PC sends a terminate request message to the network side through the CDMA terminal, and after the network side receives the message, it sends a terminate acknowledgement (ack) message to the PC through the CDMA terminal in order to achieve the link disconnection of the PPP data service.

However, it is likely that the PC is rebooted or the USB data cable is unplugged when the user performs the connection of PPP data service in the dormant state, and in this case, since the PC is not available, the PC cannot send the terminate request message to the network side through the CDMA terminal. Therefore, the connection of PPP data service is not needed any more at this moment, but the corresponding PPP link still exists for some time (such as half an hour) at the network side, and during this time, the network side still needs to maintain the related network resources and charge the user's PPP data service, thereby resulting in an unnecessary waste of network resources, and meanwhile, the user also has to pay the non-essential expenses.

### SUMMARY OF THE INVENTION

In view of the above analysis, the purpose of the present invention is to provide an apparatus and method for implementing point to point protocol data service link disconnection, to solve the problem of network resource waste since the PPP link is not disconnected instantly as well as the problem that the user has to pay unnecessary expenses in the existing PPP data service.

The purpose of the present invention is mainly implemented through the following technical solution:

an apparatus for implementing Point to Point Protocol data service link disconnection, being set in a terminal and comprising: a detection module, a processing module and a link disconnection module, wherein,

the detection module is configured to detect a state of a PC connected with the terminal when the terminal performs a Point to Point Protocol (PPP) data service in a dormant state, and inform the processing module when determining that the PC is currently in an unavailable state;

the processing module is configured to send a link disconnection request to a network side when knowing that said PC is in the unavailable state and trigger the link disconnection module when receiving a link disconnection request acknowledgement from the network side;

the link disconnection module is configured to disconnect a PPP link carrying the PPP data service.

The processing module is specifically configured to: when knowing that the PC is currently in the unavailable state, judge whether a current state of the PPP data service is the dormant state or not, if the state is determined as the dormant state, construct and send a Link Control Protocol (LCP) terminate request message to the network side, and trigger the link disconnection module after receiving a LCP terminate request acknowledgement message returned by the network side.

Said processing module specifically comprises: a judgment unit, a message transmission unit and a timing unit, wherein

the judgment unit is configured to, when knowing that the PC is currently in the unavailable state, judge whether the current state of data service is the dormant state or not, and if the state is determined as the dormant state, trigger the message transmission unit;

the message transmission unit is configured to construct and send the LCP terminate request message to the network side, and trigger the timing unit to start timing;

the timing unit is configured to detect whether the LCP terminate request acknowledgement message returned by the network side is received in a predetermined time period or not, if yes, trigger the link disconnection module, otherwise, trigger the message transmission unit to retransmit the LCP terminate request message.

The predetermined time period comprises one or more acknowledgement cycles, and the timing unit is specifically configured to: detect whether the LCP terminate request acknowledgement message returned by the network side is received in one acknowledgement cycle or not,

if yes, trigger the link disconnection module;

otherwise, trigger the message transmission unit to retransmit the LCP terminate request message, and further detect whether the LCP terminate request acknowledgement message is received after retransmitting the LCP terminate request message several times in multiple acknowledgement cycles, if yes, trigger the link disconnection module, otherwise this link disconnection processing fails.

A method for implementing point to point protocol data service link disconnection comprises:

step A: when a terminal performs a Point to Point Protocol (PPP) data service in a dormant state, detecting a state of a PC connected with the terminal;

step B: sending a link disconnection request to a network side when detecting that the PC is determined to be currently in an unavailable state, and disconnecting a PPP link carrying the PPP data service when receiving a link disconnection request acknowledgement from the network side.

The step B specifically comprises:

step B1: when the terminal determines that the PC connected with the terminal is currently in the unavailable state through detecting, judging whether a current state of data service is the dormant state or not, if the state is determined as the dormant state, proceeding to step B2;

step B2: constructing and sending a LCP terminate request message to the network side, and disconnecting the PPP link after receiving a LCP terminate request acknowledgement message returned by the network side.

The step B2 specifically comprises:

step B21: constructing and sending a LCP terminate request message to the network side and starting to carry out timing;

step B22: detecting whether the LCP terminate request acknowledgement message returned by the network side is received in a predetermined time period or not, if yes, disconnecting the PPP link, otherwise, retransmitting the LCP terminate request message to the network side.

The predetermined time period is set to comprise one or more acknowledgement cycles, and then the step B22 specifically comprises:

detecting whether the LCP terminate request acknowledgement message returned by the network side is received in one acknowledgement cycle or not:

if yes, disconnecting the PPP link;

otherwise, retransmitting the LCP terminate request message, and further detecting whether the LCP terminate request acknowledgement message is received after retransmitting the LCP terminate request message for several times in multiple acknowledgement cycles, if yes, disconnecting the PPP link, otherwise, this link disconnection processing failing.

Said detecting the state of the PC connected with the terminal is implemented by detecting whether the terminal generates a Data Terminal Ready (DTR) signal.

The beneficial effects of the present invention are as follows:

the present invention can implement that the abnormality can be detected and the related PPP data service link disconnection processing can be performed if the user unplugs the USB data cable or reboots the PC when performing the PPP data service in the dormant state, thus avoiding the waste of network resources and making the billing of the PPP data service more accurate, moreover, the user does not need to pay the non-essential expenses.

Other features and advantages of the present invention will be described in the following specification, moreover, some of them become apparent from the specification or can be understood through the implementation of the present invention. The purpose and other advantages of the present invention can be implemented and achieved through the structure particularly pointed out in the specification, the claims and the accompanying drawings.

### BRIEF DESCRIPTION OF DRAWINGS

FIG. 1 is a structural schematic diagram of said apparatus in accordance with an embodiment of the present invention;

FIG. 2 is a flow chart of said method in accordance with an embodiment of the present invention.

### PREFERRED EMBODIMENTS OF THE PRESENT INVENTION

In the following, the preferred embodiments of the present invention will be described in detail in combination with the accompanying figures, wherein, the accompanying drawings constitute a part of this application, and together with the embodiments of the present invention, it is used to explain the technical solution of the present invention. For the purpose of clarity and simplification, when it might obscure the subject of the present invention, the detailed description of known functions and structures in the apparatus described in this application will be omitted.

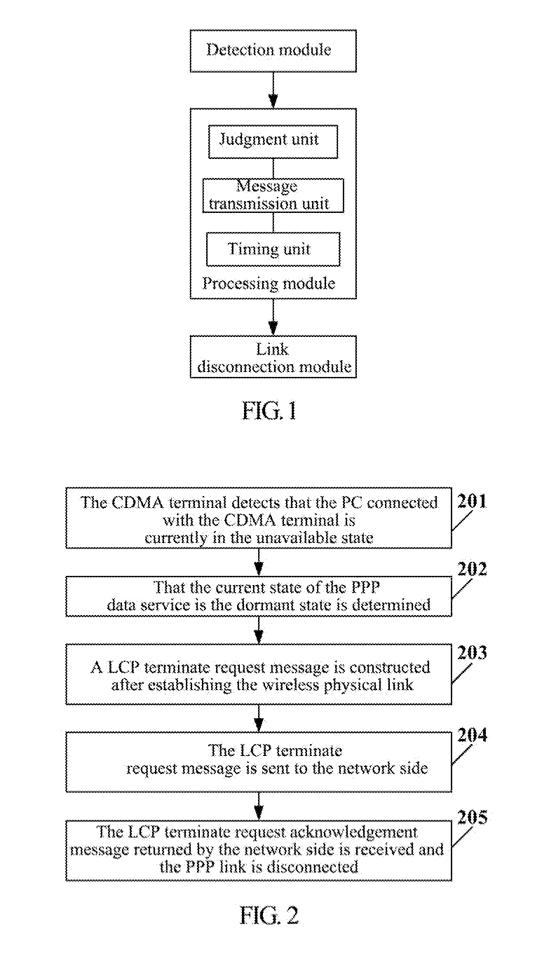

First, said apparatus in accordance with the embodiment of the present invention will be described in detail in combination with the FIG. 1.

Said apparatus in accordance with the embodiment of the present invention is set in the CDMA terminal, and when the CDMA terminal performs the PPP data service in the dormant state, if the user unplugs the USB data cable or reboots the PC, said apparatus can detect the abnormality and perform the PPP data services link disconnection processing.

As shown in FIG. 1, the FIG. 1 is a structural schematic diagram of the apparatus in accordance with the embodiment of the present invention, specifically comprising: the detection module, the processing module and the link disconnection module, wherein,

(1) the detection module is primarily responsible for detecting the state of the PC connected with the CDMA terminal, sending a PC unavailable message to the processing module when it detects that the PC connected with the CDMA terminal is currently in the unavailable state, and informing the unavailable state of the PC to the processing module;

wherein, the method for detecting the state of the PC connected with the CDMA terminal can use the method for detecting the DTR (Data Terminal Ready) signal, that is, when the user unplugs the USB data cable or reboots the PC, the CDMA terminal will generate one DTR signal, and the detection module can judge whether the state of the PC connected with the CDMA terminal is available by detecting the existence of the signal.

(2) Said processing module is configured to receive the PC unavailable message from the detection module, construct and send a link control protocol (LCP) terminate request message to the network side, and trigger the link disconnection module when receiving the LCP terminate request acknowledgement message returned by the network side;

specifically, after the processing module receives the PC unavailable message sent by the detection module, it judges whether the current state of the PPP data service is the dormant state or not, and when the state is determined as the dormant state, the processing module initializes the PPP LCP related resources after establishing the wireless link, and it constructs and sends the LCP terminate request message to the network side, and receives a terminate request acknowledgement message returned by the network side and then triggers the link disconnection module to perform the link disconnection processing, and it notifies the network side to perform the link disconnection processing at the same time, and the link disconnection module and the network side disconnect the PPP link and release the PPP LCP related resources; when the state is determined not to be the dormant state, no processing is performed;

wherein, the processing module specifically comprises: the judgment unit, the message transmission unit and the timing unit, wherein,

the judgment unit is configured to, when knowing that the PC is currently in the unavailable state, judge whether the current state of the PPP data service is the dormant state or not, and if the state is determined as the dormant state, trigger the message transmission unit;

the message transmission unit is configured to construct and send the LCP terminate request message to the network side and trigger the timing unit to start timing after being triggered by the judgment unit;

the timing unit is configured to detect whether the LCP terminate request acknowledgement message returned by the network side is received in a predetermined time period, if yes, trigger the link disconnection module, otherwise, trigger the message transmission unit to retransmit the LCP terminate request message; wherein, the predetermined time can comprise one or more acknowledgement cycles

In the embodiment of the present invention, the timing unit can use one timer, and the counting value of retransmissions of the LCP terminate request message is initialized and the timer is started, and it is detected whether the LCP terminate request acknowledgement message returned by the network side is received in one acknowledgement cycle or not:

if the LCP terminate request acknowledgement message returned by the network side is received in one acknowledgement cycle, timing is stopped and the link disconnection module is triggered to perform the link disconnection processing;

if the LCP terminate request acknowledgement message returned by the network side is not received in one acknowledgement cycle, the message transmission unit is triggered to retransmit the LCP terminate request message, and it is further detected whether the LCP terminate request acknowledgement message is received after retransmitting the LCP terminate request message several times in multiple acknowledgement cycles, and if yes, the link disconnection module is triggered and the network side is notified to disconnect the link, if the LCP terminate request acknowledgement message is still not received when the counting value of retransmissions changes to zero after the LCP terminate request message is retransmitted for several times, this link disconnection processing is considered as failed.

(3) the link disconnection module is configured to disconnect the PPP link and release the PPP LCP related resources after triggered by the processing module;

similarly, the network side receives the link disconnection request such as the LCP terminate request message from the processing module, and then it also releases the CDMA traffic channel resources and disconnects the PPP link; the specific link disconnection process can use the technical solution in the prior art, which is not repeated here.

The embodiment of the present invention adds the PPP LCP link management and link disconnection function in the CDMA terminal, applying for and initializing the PPP LCP related resources, and the link disconnection request is sent to the network side, and after the network side receives the link disconnection request, it sends a link disconnection request acknowledgement to the CDMA terminal, thus avoiding the waste of network resources and also making the billing of the PPP data service more accurate.

In the following, the method in the embodiment of the present invention will be described in detail in combination with the FIG. 2.

When the CDMA terminal performs the PPP data service in the dormant state, if the user unplugs the USB data cable or reboots the PC, the method in the embodiment of the present invention can detect the abnormality and perform the PPP data service link disconnection related processing.

As shown in FIG. 2, FIG. 2 is a flow chart of the method in accordance with the embodiment of the present invention, specifically comprising the following steps:

step 201: the CDMA terminal detects the state of the PC connected with the CDMA terminal, and proceed to step 202 when it detects that the PC connected with the CDMA terminal is currently in the unavailable state;

step 202: it is judged whether the current state of the PPP data service is the dormant state or not, and proceed to step 203 when the state is determined as the dormant state;

step 203: the PPP LCP related resources are initialized and a LCP terminate request message is constructed;

step 204: the LCP terminate request message is sent to the network side;

step 205: the LCP terminate request acknowledgement message returned by the network side is received, the PPP link is disconnected and the PPP LCP related resources are released;

specifically, the preset time is set to comprise a plurality of acknowledgement cycles, and the LCP terminate request message is sent to the network side, and the counting value of retransmissions of the LCP terminate request message is initialized at first and timing is started, and it is detected whether the LCP terminate request acknowledgement message returned by the network side is received in one acknowledgement cycle or not:

if the LCP terminate request acknowledgement message is received in one acknowledgement cycle, timing is stopped and the PPP link is disconnected, and the PPP LCP related resources are released;

if the LCP terminate request acknowledgement message returned by the network side is not received in one acknowledgement cycle, the LCP terminate request message is retransmitted, and if the LCP terminate request acknowledgement message is received after retransmitting the LCP terminate request message for several times in multiple acknowledgement cycles, the PPP link is disconnected, the PPP LCP related resources are released and the network side disconnects the PPP link, and if the LCP terminate request acknowledgement message is still not received after retransmitting the LCP terminate request message for several times in multiple acknowledgement cycles, this link disconnection processing is considered as failed.

In summary, the embodiment of the present invention provides an apparatus and method for implementing the link disconnection of point to point protocol data service, and when the CDMA terminal performs the PPP data service in the dormant state, if the PC is rebooted or the USB data cable is unplugged, the embodiment of the present invention can detect the abnormality and perform the PPP data service link disconnection related processing, so that the user can immediately end the PPP data service when the PPP data service is not in use; and when the CDMA terminal does not use the data service, the network stops the user's PPP data service, thereby reducing the waste of network resources and making the billing of the user's PPP data service more accurate.

The above description is only the specific preferred embodiments of the present invention, and it is not intended to limit the protection scope of the present invention, and any changes or replacements easily thought by those skilled in the field within the technical scope disclosed in the present invention should be included within the protection scope of the present invention. Therefore, the protection scope of the present invention should be subject to the protection scope of the claims.

What is claimed is:

1. An apparatus for implementing Point to Point Protocol (PPP) data service link disconnection, being set in a terminal, comprising: a detection module, a processing module and a link disconnection module, wherein,
the detection module is configured to detect a state of a PC connected with the terminal when the terminal performs a Point to Point Protocol (PPP) data service in a dormant state, and inform the processing module when determining that the PC is currently in an unavailable state;
the processing module is configured to send a link disconnection request to a network side when knowing that said PC is in the unavailable state and trigger the link disconnection module when receiving a link disconnection request acknowledgement from the network side;
the link disconnection module is configured to disconnect a PPP link carrying the PPP data service.

2. The apparatus of claim 1, wherein the processing module is specifically configured to:
when knowing that the PC is currently in the unavailable state, judge whether a current state of the PPP data service is the dormant state or not, and if the state is determined as the dormant state, construct and send a Link Control Protocol (LCP) terminate request message to the network side, and trigger the link disconnection module after receiving a LCP terminate request acknowledgement message returned by the network side.

3. The apparatus of claim 2, wherein said processing module specifically comprises: a judgment unit, a message transmission unit and a timing unit, wherein,
the judgment unit is configured to, when knowing that the PC is currently in the unavailable state, judge whether the current state of data service is the dormant state or not, and if the state is determined as the dormant state, trigger the message transmission unit;
the message transmission unit is configured to construct and send the LCP terminate request message to the network side, and trigger the timing unit to start timing;
the timing unit is configured to detect whether the LCP terminate request acknowledgement message returned by the network side is received in a predetermined time period or not, if yes, trigger the link disconnection module, otherwise, trigger the message transmission unit to retransmit the LCP terminate request message.

4. The apparatus of claim 3, wherein the predetermined time period is set to comprise one or more acknowledgement cycles, and the timing unit is specifically configured to: detect whether the LCP terminate request acknowledgement message returned by the network side is received in one acknowledgement cycle or not,
if yes, trigger the link disconnection module;
otherwise, trigger the message transmission unit to retransmit the LCP terminate request message, and further detect whether the LCP terminate request acknowledgement message is received after retransmitting the LCP terminate request message several times in multiple acknowledgement cycles, if yes, trigger the link disconnection module, otherwise this link disconnection processing fails.

5. A method for implementing point to point protocol data service link disconnection, the method comprising:
step A: when a terminal performs a PPP data service in a dormant state, detecting a state of a PC connected with the terminal;
step B: sending a link disconnection request to a network side when detecting that the PC is determined to be currently in an unavailable state, and disconnecting a PPP link carrying the PPP data service when receiving a link disconnection request acknowledgement from the network side.

6. The method of claim 5, wherein the step B specifically comprises:
step B1: when the terminal determines that the PC connected with the terminal is currently in the unavailable state through detecting, judging whether a current state of data service is the dormant state or not, if the state is determined as the dormant state, proceeding to step B2;
step B2: constructing and sending a LCP terminate request message to the network side, and disconnecting the PPP link after receiving a LCP terminate request acknowledgement message returned by the network side.

7. The method of claim 6, wherein the step B2 specifically comprises:
step B21: constructing and sending the LCP terminate request message to the network side and starting to carry out timing;
step B22: detecting whether the LCP terminate request acknowledgement message returned by the network side is received in a predetermined time period or not, if yes, disconnecting the PPP link, otherwise, retransmitting the LCP terminate request message to the network side.

8. The method of claim 7, wherein the predetermined time period is set to comprise one or more acknowledgement cycles, and then the step B22 specifically comprises:
detecting whether the LCP terminate request acknowledgement message returned by the network side is received in one acknowledgement cycle or not:
if yes, disconnecting the PPP link;
otherwise, retransmitting the LCP terminate request message, and further detecting whether the LCP terminate request acknowledgement message is received after retransmitting the LCP terminate request message for several times in multiple acknowledgement cycles, if yes, disconnecting the PPP link, otherwise, this link disconnection processing failing.

9. The method of claim 5, wherein, said detecting the state of the PC connected with the terminal is implemented by detecting whether the terminal generates a Data Terminal Ready (DTR) signal.

10. The method of claim 6, wherein, said detecting the state of the PC connected with the terminal is implemented by detecting whether the terminal generates a Data Terminal Ready (DTR) signal.

11. The method of claim 7, wherein, said detecting the state of the PC connected with the terminal is implemented by detecting whether the terminal generates a Data Terminal Ready (DTR) signal.

12. The method of claim 8, wherein, said detecting the state of the PC connected with the terminal is implemented by detecting whether the terminal generates a Data Terminal Ready (DTR) signal.
